(19) United States
(12) Patent Application Publication
(10) Pub. No.: US 2010/0272830 A1
(43) Pub. Date: Oct. 28, 2010

(54) Biocide Combination for use in Agricultural Applications

(75) Inventor: Giuseppe Faita, Novara (IT)

Correspondence Address: ESCHWEILER & ASSOCIATES, LLC;NATIONAL CITY BANK BUILDING, 629 EUCLID AVE., SUITE 1000, CLEVELAND, OH, 44114, US

(73) Assignee: Industrie De Nora S.p.A., Milan (IT)

(21) Appl. No.: 12/832,454

(22) Filed: Jul. 8, 2010

Related U.S. Application Data
(63) Continuation of application No. PCT/EP2009/050165, filed on Jan. 8, 2009.

(30) Foreign Application Priority Data
Jan. 9, 2008 (IT) MI2008A000027

(51) Int. Cl. A01N 59/08; A01P 1/00

(52) U.S. Cl. 424/665

(57) ABSTRACT

The invention is directed to a combination characterised by a high biocide power for use in agricultural applications, comprising a sodium or potassium hypochlorite solution and an agent allowing to generate hypochiorous acid at the moment of the application, adjusting the concentration thereof in a simple way.

### CROSS-REFERENCE TO RELATED APPLICATION

This application is a continuation of PCT/EP2009/050165 filed Jan. 8, 2009, that claims the benefit of the priority date of Italian Patent Application No. MI2008A000027 filed Jan. 9, 2008, the contents of which are herein incorporated by reference in their entirety.

### FIELD OF THE INVENTION

The invention relates to a biocide combination for use in agriculture to be prepared at the moment of application.

### BACKGROUND

Modern cultivations, in particular fruit-tree cultivations, are characterised by a high intensiveness and are, therefore, subject to destructive infestations by numerous pathogen agents present in the ground or transported by winds or by man itself. Examples of very dangerous pathogen microorganisms are Erwinia amylovora, causing the fire blight of bacterial origin evidenced by a darkening of stems, leaves and flowers of several kinds of trees, such as the pear tree of the white William variety, or Valsa ceratosperma and Nectria galligena, producing a degeneration of branches and trunks in the form of cankers with clean and deeply cracked edges.

For the sake of keeping these and other microorganisms under control, agricultural companies resort to the sprinkling of plants with biocide substances not always obtaining satisfactory control of the plague, and that in any case are noxious for the operators and pollutants of the environment, in addition to being expensive. In the past, there have been attempts at replacing these substances with commercial solutions of sodium hypochlorite, which did not prove effective. The reason for such low biocide activity is to be found in the presence of significant concentrations of free caustic soda, typically 0.25%-0.35% by weight, whereto the task of hypochlorite stabilisation is deputed (see, for instance, Ullmanns Encyclopeida of Industrial Chemistry, 3^{rd} edition, pg. 503). Caustic soda shifts the ratio of sodium hypochlorite, NaClO, to hypochlorous acid, HClO, towards the former, in accordance with the reaction:

HClO+NaOH→NaClO+H₂O

The stabilising effect of caustic soda is well explained considering that hypochlorous acid is quickly decomposed (HClO→HCl+1/2 O₂), contrary to sodium hypochlorite which gives rise to the same reaction in a much longer time. This positive stabilising effect of commercial solutions is counteracted, however, by the lesser biocide activity of sodium hypochlorite compared to that of hypochlorous acid, so that commercial solutions are generally used for relatively mild sterilisations, in particular against very sensitive microorganisms, while they are ineffective in the case of more virulent microorganisms, such as the case of microorganisms previously mentioned as the cause of destructive plagues in industrial orchards. It should also be added that caustic soda present as a stabilising agent in commercial solutions is harmful to the integrity of treated parts, being liable to provoke hydrolytic reactions of the vegetal tissue.

On the other hand, hypochlorous acid instability prevents the distribution of solutions prepared in distributing centres because the quick rate of decomposition turns the solutions inactive before they can be applied to plants. Such situation was discussed in the co-pending Italian Patent Application MI 2007A001863, incorporated by reference herein in its entirety. In this document, there is disclosed the electrolysis of an alkali chloride—for instance sodium or potassium chloride—dilute solution, to be carried out in a suitable cell with the purpose of producing a solution having a significant hypochlorous acid concentration generally comprised between 0.01 g/l (grams/liter) and 2 g/l. Once prepared, such solution is directly sprinkled on the orchards, so that the amount of hypochlorous acid lost by decomposition is negligible. It is also foreseen that the cell may be installed directly on board of the vehicle employed for the application.

For some users, the management of an electrochemical cell in field and orchard sprinkling treatments may nevertheless represent an undesired and hardly acceptable complication.

Under one aspect, it is an object of the invention to provide a solution of high biocide capacity containing a predefined significant concentration of hypochlorous acid by a purely chemical way.

This and other objects will be made clear by the following description, which shall not be intended as limiting the invention, whose extent is solely defined by the appended claims.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, the invention comprises, under one aspect, combination comprising a basic hypochlorite solution and a pH-adjusting activating agent, for simultaneous, separate or sequential use in biocide treatments for agricultural applications wherein the basic solution and the activating agent are packaged in a dosage such as to provide a predetermined pH value comprising between about 5 and about 8 upon mixing.

Under another aspect, the invention comprises a method for preventive or therapeutic biocide treatment for agricultural applications comprising the simultaneous or sequential steps of pre-dosage of a basic hypochlorite solution, optional dilution of the pre-dosed basic hypochlorite solution, dosage of a pH-adjusting activating agent, mixing of the basic hypochlorite solution and the activating agent until obtaining a solution containing hypochlorous acid of concentration comprised between 0.1 and 2 g/l, and application of the hypochlorous acid-containing solution within one hour from the mixing.

To the accomplishment of the foregoing and related ends, the following description sets forth certain illustrative aspects and implementations. These are indicative of but a few of the various ways in which one or more aspects may be employed. Other aspects, advantages, and novel features of the disclosure will become apparent from the following detailed description.

### DETAILED DESCRIPTION

Under a first aspect the invention comprises a combination comprising a basic hypochlorite solution and a pH-adjusting activating agent for simultaneous, separate or sequential use in biocide treatments for agricultural applications. In one embodiment, the basic solution and the activating agent constituting the combination are pre-packaged in ready-to-use single doses. The activated solution for the biocide treatment is obtained by mixing the hypochlorite basic solution with the activating agent, preferably in predefined single doses capable of providing a hypochlorous acid concentration of predetermined value. In one embodiment, the hypochlorous acid predetermined value of the activated solution prepared by mixing the two components of the combination is comprised between 0.1 and 2 g/l.

In one embodiment, the pH of the activated solution prepared by mixing the two components of the combination will be between about 5 and about 8, and in one embodiment between about 6 and about 7.

In one embodiment, the basic solution comprises a commercial hypochlorite solution, for instance sodium or potassium hypochlorite, stabilised with caustic soda and optionally to be diluted with water before using. In one embodiment, the activating agent comprises a solid product, optionally comprising at least one compound characterised by a buffering action or a cation-exchange resin in acidic form.

In one embodiment, the activating agent is a solution containing at least one compound characterised by a buffering action.

In one embodiment, the activating agent comprises a buffer containing alkali phosphates in solid form or in solution.

In one embodiment, the activated hypochlorite solution is prepared by mixing the basic hypochlorite solution and the activating agent at the moment of the application in the preventive or therapeutic treatment of plagues induced on plants by microorganisms such as fungi and bacteria.

Under another aspect, the invention comprises a preventive or therapeutic biocide treatment in agricultural applications comprising the mixing of a basic hypochlorite solution and an activating agent in solid form or in solution containing 0.1 to 2 g/l of hypochlorous acid, and the application of the solution to the cultivation to be treated within one hour from the mixing.

In one embodiment, the hypochlorite solution and the activating agent to be mixed are pre-dosed by the manufacturer and ready-to-use. In another embodiment, the hypochlorite solution is pre-dosed for a subsequent dilution in known proportions with water, for instance civil water, prior to the mixing with the pre-dosed activating agent.

In another embodiment, the basic hypochlorite solution comprises a commercial sodium or potassium hypochlorite solution stabilised with caustic soda or potash.

Commercial solutions of hypochlorite, in the most common case of sodium hypochlorite, can have a typical concentration of 15-20% by weight and contain on average 12-16% of sodium chloride and 2.5-3.5% of caustic soda used as a stabiliser, imparting a pH of about 13 to the solution (cfr. Ullmanns Encyclopeida of Industrial Chemistry, Vol. 5, 3^{rd} ed., pg. 503). These solutions are characterised by a relatively mild sterilising power. The content of hypochlorous acid, which is the component of higher biocide activity, is in fact present in extremely reduced amounts, since its concentration is a reciprocal function of pH. In particular, at 25° C., a temperature close to that of agricultural applications, hypochlorous acid concentration expressed as percentage of total hypochlorite concentration is a function of pH as indicated in the following Table 1:

TABLE 1
Hypochlorous acid (HClO) concentration expressed as percentage of
total hypochlorite concentration as a function of pH at 25° C. (*)

| pH | HClO, % |
|---|---|
| 5 | 99.7 |
| 6 | 96.9 |
| 7 | 76.0 |
| 8 | 24 |
| 9 | 3.1 |
| 10 | 0.31 |
| 11 | 0.03 |
| 12 | 0.003 |

(*) Kirk - Othmer Encyclopaedia of Chemical Technology, 2^{nd} Edition, Vol. 4, pg. 911

The problem of low concentration of hypochlorous acid is not eliminated by the required dilution for bringing the concentration of total hypochlorite (sodium hypochlorite+hypochlorous acid) to the maximum value of 2 g/l which the testing disclosed in the cited Italian Patent Application MI 2007A001863 showed to be optimal for a sterilising action free of negative consequences for the plants and the environment. With such dilution, caustic soda is brought to an average concentration of 0.025-0.035 g/l, corresponding to a pH of about 11. From the above Table 1 it is apparent that also in this situation, hypochlorous acid concentration is totally negligible. Hence, also the diluted solution is characterised by an unsatisfactory biocide activity.

An obvious measure could be given by an injection of acid, for instance hydrochloric acid, into the diluted solution, wherein the acid would neutralise the free alkalinity forming free hypochlorous acid:

NaOH+HCl→NaCl+H₂O

NaClO+HCl→HClO+NaCl

However, an excess of hydrochloric acid would produce elemental chlorine (Cl₂) according to the following reaction:

HClO+HCl→Cl₂+H₂

The above reactions demonstrate how the hydrochloric acid addition has to be carefully controlled in order to avoid the conversion of hypochlorous acid to chlorine which would be subsequently released to the working environment with negative consequences for the operators. The sensitivity of the acid addition step would require the use of control instruments such as pH detectors. This practical complication, added to the intrinsic hazard of handling commercial concentrated hydrochloric acid (35-37% by weight) and to the need of diluting the same hydrochloric acid before adding it to the hypochlorite solution clearly indicate that this way of preparation of a solution having a high biocide activity, no matter how feasible in a chemical lab, is conversely not compatible with procedures and competences typical of agricultural companies.

It was found that the above difficulties can be overcome if the solution obtained by a dilution of about 1:100 of commercial hypochlorite is added with a predefined amount of an activating agent comprising an acidifying product, solid or in solution, capable of producing a controlled pH.

In one embodiment of the invention, the solid activating agent comprises an ion-exchange resin, for example, a cation-exchange resin. Resins of this kind are known in the art for their use in water demineralisation. Ion-exchange resins consist of a polymer, for instance a styrene-divinylbenzene copolymer, subjected to a sulphonation reaction with introduction of sulphonic groups —SO₃⁻ in the aromatic rings. Products of this kind are commercialised under different trade names (see, Kirk-Othmer Encyclopaedia of Chemical Technology, 2^{nd} ed., Vol. 11, pg. 871), such as Amberlite® and Duolite® (both registered trade-marks of Rohm and Haas), Dowex® (a registered trade-mark of Dow Chemical Company), Ionac® and Lewatit® (both registered trade-marks of Sybron Chemicals/LanXess). The required electroneutrality of resins is assured by a positive counterion balancing the negative charge of sulphonic groups. The counterion can be a cation, in particular Na⁺ or H⁺. The introduction of H⁺ can be easily obtained by treating the resin with an acid solution, for instance hydrochloric acid or sulphuric acid. The acidic form of the resin, which can be represented in a simplified way by the formula R—SO₃⁻H⁺, wherein R identifies the polymer backbone, is a commonly commercialised product. The R—SO₃⁻H⁺ resin behaves for all purposes as an acid and, if added to the diluted hypochlorite solution, reacts in a fashion analogous to hydrochloric acid as mentioned above, without presenting the same problems of dangerousness and dosage:

R—SO₃⁻H⁺+NaOH→R—SO₃⁻Na⁺+H₂O

R—SO₃⁻H⁺+NaClO→R—SO₃⁻Na⁺+HClO

Also, the addition of a possible excess of resin would lead to the formation of chlorine much in the same way as seen above in the case of hydrochloric acid:

R—SO₃⁻H⁺+NaCl→R—SO₃⁻Na⁺+HCl

HClO+HCl→Cl₂+H₂O

Nevertheless, a sufficiently accurate calibration of the required amount of resin is relatively simple, given the quantities involved. Cationic resins in acidic form are characterised by a precise and reproducible acidifying capacity expressed as equivalents per litre of resin, normally comprised between 2 and 4 eq/l depending on the selected resin type. For example, for any 100 l of diluted solution containing 1 g/l of sodium hypochlorite, 0.7 l of resin of the type characterised by an acidification capacity of 2 eq/l must be added for a complete conversion to hypochlorous acid, or 0.35 l in case a conversion to hypochlorous acid of 50% is desired. The presence of free caustic soda at the very low levels typical of hypochlorite diluted solutions has a negligible effect.

As it has been said, a resin overdosing is unlikely in view of the involved amounts. In one embodiment, the hypochlorite solution and the resin are provided jointly in predefined doses as a kit, eliminating any possibility of error. The problem of a possible overdosing can be further minimised if instead of sulphonic ion-exchange resins (known as strong resins), carboxylic ion-exchange resins (known as weak resins) are used, for instance produced by polymerisation of acrylic, methacrylic or maleic acid followed by three-dimensional cross-linking with divinylbenzene. These resins can be represented by the simplified formula R′—COOH wherein R′ identifies the polymer backbone and —COOH the carboxylic group characterised by weak acidity. The functioning of carboxylic resins introduced into the diluted hypochlorite solution is analogous to what is seen above in the case of sulphonic resins:

R′—COOH+NaOH→R′—COO⁻Na⁺+H₂O

R′—COOH+NaClO→HClO+R′—COO⁻Na⁺

Due to its intrinsic weak acidity, the resin, even though added in excess to the diluted hypochlorite solution, is not capable of lowering the pH below approximately 5, a condition in which chlorine (Cl₂) is present in a negligible amount (see Kirk-Othmer Encyclopaedia of Chemical Technology, 2^{nd} Edition, Vol. 4, pg. 911). Carboxylic resins can therefore be appropriately regarded as a self-limiting system for pH final value, which is kept within safety limits even in case of gross overdosing caused by the operators' lack of attention.

In an alternative embodiment to providing a pre-dosed kit, the required amounts of resin can be determined by weighing with a conventional scale, or more comfortably and quickly by a scoop provided with filling marks. The scoop remains usable provided the volumes of the single lots and the concentration of hypochlorite solution are kept constant. To achieve the latter condition it is necessary to insert in the ordering specifications of the solution the required hypochlorite concentration, which is preserved unaltered at least for a few weeks due to the stabilising action of free caustic soda, keeping the solution in a fresh indoor environment not exposed to direct sunlight. The preparation of the activated solution is carried out by diluting the hypochlorite solution, for instance from 0.5 l (litres) to 100 l, and adding the quantity of resin withdrawn from the supplied bag, normally in the form of pellets with a diameter of about 2 mm, preferably making use of a calibrated scoop. The solution is kept under stirring, optionally by hand, for a few minutes.

In one embodiment, the strong or weak-type resin employed as the activating agent, rather than being supplied as pellets as normally commercialised, is previously milled in order to obtain a powder to be dispersed under manual stirring into the hypochlorite diluted solution. In this way, the time needed to convert hypochlorite to hypochlorous acid is reduced.

Upon completing the stirring step, the resin in sodium form settles on the bottom of the vessel, where it may be left without any effect to the effectiveness of the treatment. The exhausted resin, recovered soon after the end of the stirring and the application of the activated solution to the plants, may be advantageously returned to the relevant supplier which will proceed to the regeneration thereof at his own production site (the H⁺ to Na⁺ exchange being a reversible process). The use of the activated solution for plant treatment must occur in a short time, particularly if sodium hypochlorite is completely converted to hypochlorous acid, in order to prevent hypochlorous acid decomposition from lessening the treatment efficacy to an excessive extent.

As it can be noticed, the preparation of the activated solution according to the invention does not imply the handling of acid solution, either concentrated or diluted, nor complicated dosage systems, because the whole operation is carried out manually without using any particular equipment. Depending on the fact that the two components of the kits be supplied or not in a pre-dosed form, there may be required only a calibrated vessel for sampling fixed amounts of hypochlorite solution, a vessel of known volume for the optional dilution of the sampled amount of hypochlorite with tap water, a calibrated scoop for withdrawing a known and constant amount of resin, a blade for the manual stirring of the mixture of two components and a device, for example a sprinkler, for applying the activated solution to the plants to be treated. The preparation of the activated solution according to the invention is thus entirely compatible with the normal compound sampling and mixing procedure carried out routinely in agricultural companies for obtaining fertilising or parasiticide formulations, with the important advantage of utilising products generally harmless to the environment and the operators.

An important aspect concerning any hypochlorite-containing solutions is given by the chlorate content which is considered harmful to the environment or even to the very plants that are to be treated. Chlorate may be generated by conversion of hypochlorite during the production step itself or during a long-term storage. While hypochlorite conversion to chlorate during long-term storage of commercial solutions is kept under control by the presence of free caustic soda, the formation of chlorate during the manufacturing of commercial solutions can be significantly reduced if the temperature is controlled around 20-30° C. Taking this possibility into account, the hypochlorite solution employed must preferably have a maximum chlorate content of 0.1 g/l.

In one embodiment, the basic hypochlorite solution is a potassium hypochlorite solution, suitable for simultaneously administering hypochlorous acid and potassium, which is an important element for the regular growth of certain types of plants. The hypochlorite solution in this case is produced by absorbing chlorine in a solution of caustic potash (KOH) with the same precautions of temperature and potash residual concentration control analogous to those discussed for sodium hypochlorite solutions.

Results equivalent to those obtainable with ion-exchange resins can be achieved by adding an activating agent consisting of a solution having a controlled acidifying power, harmless to the environment and the operators.

It was found that a solution comprising sodium diacid phosphate (NaH₂PO₄, for instance 100 g/l) is particularly fit to the scope of the invention. Such solution can be added to a diluted hypochlorite solution (for instance adding 3 l to 100 l at a concentration of 1 g/l of hypochlorite) by means of a calibrated vessel. In one embodiment, the sodium diacid phosphate activating solution and the hypochlorite solution are supplied in a pre-dosed kit requiring a simple mixing of the two components.

The reactions involved in such mixing are analogous to those seen with ion-exchange resins:

NaH₂PO₄+NaOH→Na₂HPO₄+H₂O

NaH₂PO₄+NaClO→Na₂HPO₄+HClO

If the added amount of diacid phosphate exceeds the required one, the simultaneous presence of diacid and monoacid phosphates (NaH₂PO₄ and Na₂HPO₄ respectively) contributes to establishing a buffering action capable of stabilising the pH around useful values for the generation of hypochlorous acid predefined concentrations. For this reason the activating agent, even when added in excess with respect to the predetermined dose due to carelessness of the operators, is not capable of lowering the pH below 6.5-7.0, thereby maintaining a condition wherein hypochlorous acid is approximately 75% of total hypochlorite, without running any risk of generating free chlorine (Cl₂). In one embodiment, the activating agent comprises a solution containing potassium diacid phosphate (KH₂PO₄).

In one embodiment, the activating agent is added in the form of powder. In this case, the sampling is effected by weighing of a fixed amount of product or more easily by means of a calibrated scoop equivalent to the one that can be used for resins.

In one embodiment, the hypochlorite solution and the solid activating agent, for instance comprising sodium diacid phosphate, are supplied in a pre-dosed kit. In one embodiment, the solid activating agent comprises potassium diacid phosphate (KH₂PO₄) powder.

The indicated formulations, based on sodium or potassium diacid phosphates, are not exhaustive of the range of solutions or powders useful in the preparation of activating buffering agents which can be employed for controlling the acidity. In one embodiment, several compounds known as reference standards for pH-metry can be used for this purpose (see G. Bianchi & T. Mussini, Elettrochimica, Tamburini Masson Editori, pg. 226).

The use of the active solution prepared starting from the combination according to the invention in the treatment of plants must occur within a limited time, in particular when sodium hypochlorite conversion is complete, regardless of the selected embodiment, in order to prevent hypochlorous acid decomposition from lessening the treatment efficacy to an excessive extent.

### EXAMPLE 1

An activated solution containing hypochlorous acid was prepared as follows:
Purchase of a sodium hypochlorite commercial solution at a concentration of 200 g/l containing 160 g/l of sodium chloride, 3 g/l of free caustic soda as stabiliser and 0.1 g/l of chlorate;
Dosing of the sodium hypochlorite solution by dilution of 0.5 l to 100 l by tap water addition. The pre-dosed diluted solution was characterised by a final concentration of 1 g/l sodium hypochlorite (analytically confirmed) and 0.8 g/l sodium chloride, at pH 8.6;
Dosing of the activating agent by sampling of 0.5 g/l of cation-exchange resin type Lewatit MonoPlus™ S100H (strong cation-exchange resin commercialised by Sybron Chemicals Inc. already in acidic form, characterised by an acidifying capacity of 1.8 eq/l) using a calibrated 1 litre vessel;
Formation of the activated solution by mixing of the previously dosed hypochlorite solution and activated agent under manual stirring;
pH detection of a known volume of activated solution as a function of contact time (t): 8.6 at t=0 minutes, 8 at t=5 minutes, 7.5 at t=15 minutes. This value of pH, which didn't have any more significant variation in time, corresponds to a 65% conversion of the initial sodium hypochlorite, equal to a hypochlorous acid concentration of 0.5 g/l.
   The activated solution, whose temperature was 23° C., was analysed in the course of time to check its stability. It was found that the total hypochlorite loss (hypochlorous acid+sodium hypochlorite) was 3% one hour after the preparation and 10% after 2 hours. These times are compatible to the one required to proceed with the application of the activated solution to the plants.

The preparation was repeated introducing 0.75 litres of the same resin into a new 100 l bulk of diluted hypochlorite solution, again using the calibrated vessel. A final pH of 6.2 was detected, corresponding to a 95% conversion of original hypochlorite to hypochlorous acid.

The stability of this new solution was checked, and a decay of about 6% after 1 hour and 15% after 2 hours at 21° C. was detected.

The preparations were repeated several times, verifying a satisfactory reproducibility of the results.

The activated solution according to the invention was applied, always within one hour from the preparation, to some pear trees of the white Williams variety of the same orchard used as test field in the experimentation described in example 1 of the co-pending Italian patent application MI 2007A001863. By following an analogous procedure, at the end of the treatment cycle it was observed that the fire blight plague induced by the Erwinia amylovora bacterium was substantially reduced.

Some activated solutions were prepared in an equivalent fashion making use of resin Lewatit® CNP 80 (a weak cation-exchange resin provided by manufacturer Sybron Chemicals Inc. already in acidic form). In this case, the added amounts were recalculated as a function of the higher ion-exchange capacity: in particular, it was found that the same results presented above can be obtained respectively with 0.25 and 0.4 l of resin. It was also noticed that a resin overdosing did not produce any chlorine release, as it would have happened by using strong cation-exchange resins of the type Lewatit MonoPlus™ S100H. It was observed that pH is stabilised in any case around a value of 5-5.5. The reason for this behaviour, which allows preventing problems in case of errors in the addition, is to be found in the nature of functional group which in the case of weak cation-exchange resins, such as Lewatit® CNP 80, consist of carboxyls characterised by a slight tendency to acid release, contrary to what happens with sulphonic groups of strong cation-exchange resins such as MonoPlus™ S100H.

The preparation procedure of the activated solution is simple, since it just requires diluting samples of an easily purchasable commercial solution with normal tap water and adding predetermined volumes of strong or weak cation-exchange resin, easily available on the market. These quantities remain fixed provided the volume of diluted hypochlorite solution is the same for all preparation lots and that the commercial sodium hypochlorite solution is acquired according to ordering specifications stipulating the required hypochlorite concentration and free caustic soda concentration. If necessary, in the ordering specifications there can be indicated that the solution must contain potassium rather than sodium hypochlorite, in case the presence of potassium might play a positive role; in the same way, the maximum allowable chlorate content can be specified.

It is apparent, however, that the preparation of the solution according to the invention is made even easier and error-proof when the amounts of hypochlorite solution and activating agent, prepared as described, are provided to the final user as pre-packaged doses of a kit for agricultural applications.

### EXAMPLE 2

An activated solution containing hypochlorous acid was prepared as follows:
Dosing of the sodium hypochlorite solution by dilution of 0.5 l of the commercial solution of Example 1 to 100 l by tap water addition. The pre-dosed diluted solution was therefore characterised by a final concentration of 1 g/l sodium hypochlorite (analytically confirmed) and 0.8 g/l sodium chloride, at pH 8.6;
Preparation of an activating agent consisting of a sodium diacid phosphate (NaH₂PO₄) solution at a concentration of 100 g/l;
Dosing of the activating agent by sampling of 2.5 litres of the above solution making use of an appropriate calibrated vessel;
Formation of the activated solution by mixing of the previously dosed hypochlorite solution and activated agent under manual stirring;
pH detection of a known volume of activated solution as a function of contact time (t): 8.6 at t=0 minutes, 6.9 at t=5 minutes with no further sensible variation, corresponding to a 75% conversion of the initial sodium hypochlorite, equal to a hypochlorous acid concentration of 0.6 g/l.
   The activated solution, whose temperature was of 21° C., was analysed in the course of time to check its stability, with results similar to those presented in Example 1.
   Also this preparation procedure turns out to be simple and compatible with the normal operation of agricultural companies.
   It is apparent however how also in this case the preparation of the solution according to the invention is made even easier and error-proof when the amounts of hypochlorite solution and of phosphate , prepared as described, are provided to the final user as pre-packaged doses of a kit for agricultural applications.

Further tests allowed verify that, by means of the procedures described in this and in the previous example, it is possible to produce without difficulty activated solutions containing a wide range of hypochlorous acid concentrations comprised between 0.01 and 2 g/l.

The tap water used for the preparation of diluted hypochlorite solutions of the two examples was characterised by a calcium bicarbonate content of 215 mg/l, negligible as concerns the attainment of the required pH values. In case waters employed for the dilution of the concentrated hypochlorite solutions are characterised by a particularly high calcium hardness, for example of about 1000 mg/l calcium bicarbonate, it may be necessary to perform a correction in the dosage of the activating agent or even better in the dilution of the hypochlorite solution. The dosage correction can be effected by the user or directly by the manufacturer, which may be able to provide a range of alternative products depending on the hardness of the water available to the user.

The previous description is not intended to limit the invention, which may be used according to different embodiments without departing from the scopes thereof, and whose extent is univocally defined by the appended claims.

Throughout the description and claims of the present application, the term “comprise” and variations thereof such as “comprising” and “comprises” are not intended to exclude the presence of other elements or additives.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention before the priority date of each claim of this application.

1. A combination comprising:
a basic hypochlorite solution; and
a pH-adjusting activating agent;
for simultaneous, separate or sequential use in biocide treatments for agricultural applications wherein the basic solution and the activating agent are packaged in a dosage such as to provide a predetermined pH value comprising between about 5 and about 8 upon mixing.

2. The combination according to claim 1, wherein the predetermined pH comprises between about 6 and about 7.

3. The combination according to claim 1, wherein the basic solution comprises sodium hypochlorite and/or potassium hypochlorite stabilised with free caustic soda and/or potash.

4. The combination according claim 1, wherein the activating agent comprises a cation-exchange resin in acidic form.

5. The combination according to claim 4, wherein the cation-exchange resin comprises a strong cation-exchange resin provided with sulphonic functional groups or a weak cation-exchange resin provided with carboxylic functional groups.

6. The combination according to claim 1, wherein the activating agent comprises at least one compound with buffering properties, either solid or in solution.

7. The combination according to claim 6, wherein the at least one compound with buffering properties comprises a sodium or potassium diacid phosphate.

8. The combination according to claim 1, wherein the basic solution and the activating agent are packaged in a dosage such as to generate hypochlorous acid of concentration comprised between about 0.1 and about 2 g/l.

9. Method of preventive or therapeutic biocide treatment for agricultural applications comprising the simultaneous or sequential steps of:
pre-dosage of a basic hypochlorite solution;
optional dilution of the pre-dosed basic hypochlorite solution;
dosage of a pH-adjusting activating agent;
mixing of the basic hypochlorite solution and the activating agent until obtaining a solution containing hypochlorous acid of concentration comprised between 0.1 and 2 g/l; and
application of the hypochlorous acid-containing solution within one hour from the mixing.

10. The method according to claim 9, wherein the steps of pre-dosage of a basic hypochlorite solution and of dosage of an activating agent are carried out during the manufacturing stage of a combination.

11. The method according to claim 9, wherein the optional dilution of the pre-dosed basic hypochlorite solution is carried out with tap water.

12. The method according to claim 9, wherein the basic hypochlorite solution comprises a commercial alkali hypochlorite solution and the optional dilution is carried out with tap water.
